(19) United States
(12) Patent Application Publication
(10) Pub. No.: US 2013/0030888 A1
(43) Pub. Date: Jan. 31, 2013

(54) SYSTEM FOR ALLOWING CUSTOMERS TO CHOOSE REWARDS

(71) Applicants: Matthew A. Calman, Charlotte, NC (US); Margery Kiehn, Greensboro, NC (US); Jamie Armistead, San Francisco, CA (US); Erik Stephen Ross, Charlotte, NC (US); Sanchit Gupta, Jersey City, NJ (US); Shoshana Tzipporah Asher Holtzblatt, New York, NY (US); Honray Lin, San Mateo, CA (US); Molly Nix, Concord, MA (US); Sriram Ramasubramanian, Sunnyvale, CA (US)

(72) Inventors: Matthew A. Calman, Charlotte, NC (US); Margery Kiehn, Greensboro, NC (US); Jamie Armistead, San Francisco, CA (US); Erik Stephen Ross, Charlotte, NC (US); Sanchit Gupta, Jersey City, NJ (US); Shoshana Tzipporah Asher Holtzblatt, New York, NY (US); Honray Lin, San Mateo, CA (US); Molly Nix, Concord, MA (US); Sriram Ramasubramanian, Sunnyvale, CA (US)

(73) Assignee: BANK OF AMERICA CORPORATION, Charlotte, NC (US)

(21) Appl. No.: 13/357,349

(22) Filed: Jan. 24, 2012

Related U.S. Application Data
(60) Provisional application No. 61/513,266, filed on Jul. 29, 2011.

(51) Int. Cl. G06Q 30/02

(52) U.S. Cl. 705/14.14; 705/14.1

(57) ABSTRACT

Embodiments of the invention relate to systems, methods, and computer program products for allowing a customer to choose rewards as part of a customer incentive program by receiving a first customer input, wherein the first customer input is a characteristic of the customer, receiving a second customer input, wherein the second customer input is a category of reward in which the customer is interested, correlating the first customer input to a plurality of activities to be completed by the customer, correlating the second customer input to rewards to be provided to the customer for completing an activity, monitoring the customer's activities to determine when the customer has completed an activity and providing a reward to the customer corresponding to the completed activity.

### CROSS-REFERENCE TO RELATED APPLICATIONS

This application claims priority to U.S. Provisional Patent Application Ser. No. 61/513,266, filed Jul. 29, 2011, entitled “System for Allowing Customers to Choose Their Rewards,” the entirety of which is incorporated herein by reference.

### FIELD

In general, embodiments of the invention relate to methods, systems, apparatus and computer program products for allowing a customer to choose rewards as part of a customer incentive program.

### BACKGROUND

Many merchants, e.g. retailers, financial institutions etc., provide their customers with incentives programs to encourage specific customer behavior. Typically, customers that participate in these programs receive a predetermined benefit in exchange for demonstrating the desired behavior. Because such incentives programs are likely to attract more customer participants if the customer can determine the nature of the benefit to be received, there is a need for a customer incentives program in which customers can choose the benefits they receive for participating.

### SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Some embodiments provide a method for allowing a customer to choose a reward involving receiving a first customer input, wherein the first customer input is a characteristic, receiving a second customer input, wherein the second customer input is a category of rewards, correlating the first customer input to a plurality of activities to be completed by the customer, correlating the second customer input to rewards to be provided to the customer for completing the activity, monitoring the customer's activities, determining when the customer has completed an activity and providing a reward to the customer corresponding to the completed activity. In some embodiments the first customer input is an indication from the customer that the customer would like to be assigned a random characteristic. In such embodiments the method also includes the step of assigning a random characteristic to the customer. Similarly, in some embodiments, the second customer input is an indication from the customer that the customer would like to be assigned a random category of reward. In such embodiments the method will also involve assigning a random category of reward to the customer.

In certain embodiments the plurality of activities that are correlated to the first customer input are selected from: participating in a specified program, maintaining a specified balance in an account, meeting specific goals, using online tools provided by the merchant, completing a transaction with a specified financial instrument, remaining a customer of the merchant for a specified period of time, or referring other customers to become customers of the merchant. In some embodiments the rewards correlated to the second customer input are selected from: discounts for goods, discounts for services, access to preferred services, or reductions in service fees.

Some embodiments of the invention further comprise identifying a plurality of activity segments, wherein each segment corresponds to a value to the merchant of the completion of the activity and determining to which activity segment an activity belongs. In such embodiments, correlating the second customer input to rewards to be provided to the customer for completing an activity is based in part on the activity segment to which an activity belongs.

Consistent with certain embodiments of the invention, the method will further involve creating a social network, wherein a customer can elect to associate with one or more customers. In some such embodiments, customers within the social network can communicate with each other and may be able to gift rewards to other customers within the social network. In such instances, the gifts may be tied to the other customer's completion of an activity.

In some embodiment the method further comprises the steps of presenting, via a display, a first image, wherein the first image is a visual representation of the first customer input, correlating the customer's activities to an image and presenting, via the display, a second image, wherein the second image is the image associated with the customer's activities. In certain embodiments the first and second images will take the form of an avatar. Consistent with some embodiments, the second image may be a visual representation of the first image modified to illustrate the customer's completion of activities associated with the first customer input. The first and second images may be visible to other customers within the social network.

Embodiments of the invention also provide an apparatus that includes a user interface for receiving a first and second customer input from a customer, wherein the first customer input is a characteristic and the second customer input is a category of reward. The apparatus also includes a memory, which is operatively connected to the user interface and configured to store the first and second customer inputs. The apparatus also features a processor that is operatively connected to both the memory and the user interface and is configured to correlate the first customer input to a plurality of activities to be completed by the customer, correlate the second customer input to rewards to be provided to the customer for completing an activity, monitor the customer's activities, determine when the customer has completed one or more of the plurality of activities and provide a reward to the customer corresponding to the completed activity. In certain embodiments, the first customer input is an indication from the customer that the customer would like to be assigned a random characteristic and the processor is configured to assign a random characteristic to the customer. In other embodiments, the second customer input is an indication from the customer that the customer would like to be assigned a random category of reward and wherein the processor is further configured to assign a random category of reward to the customer.

In some embodiments, the processor is further configured identify a plurality of activity segments, wherein each segment corresponds to a value to the merchant of the completion of an activity by the customer and to determine to which segment an activity belongs. In such embodiments, the processor, in correlating the second customer input to rewards to be provided to the customer for completing an activity is based in part on the activity segment to which an activity belongs.

In further embodiments, the processor is also configured to create a social network, wherein customers can elect to associate with one or more other customers. In some embodiments of the social network, customers will be able to communicate with other customers and/or gift rewards to other customers. In yet further embodiments of the apparatus, the apparatus will include a display, and the processor will be configured to present, via the display, a first image, wherein the first image is a visual representation of the first customer input. The processor may also be configured to correlate the customer's activities to an image and present via the display, a second image, wherein the second image is the image associated with the customer's activities. In some such embodiments, the second image may be a visual representation of the first image modified to illustrate the customer's completion of activities associated with the first customer input and the first and second image may be visible to other customers in the social network.

Embodiments of the invention also provide a computer program product, comprising a non-transitory computer-readable medium having computer-executable code stored thereon, the computer executable code comprising multiple different code portions, including a first code portion configured to receive a first customer input from a customer and a second code portion configured to receive a second code portion from the customer. In some embodiments the first customer input is a characteristic and in other embodiments the first customer input is an indication from the customer that the customer would like to be assigned a random characteristic. In the later embodiments, the computer program product includes a code portion for randomly assigning a characteristic to the customer. In some embodiments the second customer input is a category of reward and in other embodiments the second customer input is an indication from the customer that the customer would like to be assigned a random category of reward. In the later embodiments, the computer program product includes a code portion for randomly assigning a reward category to the customer. The computer program product may also include a third code portion configured to correlate the first customer input to a plurality of activities to be completed by the customer, a fourth code portion configured to correlate the second customer input to rewards to be provided to the customer for completing an activity, a fifth code portion configured to monitor the customer's activities, a sixth code portion for determining when the customer has completed one or more of the plurality of activities and a seventh code portion configured to provide a reward to the customer corresponding to the completed activity.

Certain embodiments of the computer program product also include an eighth code portion stored in the memory and configured to identify a plurality of activity segments, wherein each segment corresponds to a value to the merchant of the completion of an activity by the customer and a ninth code portion stored in the memory and configured to determine to which segment an activity belongs.

The computer program product may also include code portions configured to create a social network wherein customers can elect to associate with one or more other customers. In such a social network, the customers may be able to communicate with each other and/or gift rewards to other customers. In further embodiments, the computer program product includes additional code portions for presenting via a display a first image, wherein the first image is a visual representation of the first computer input, correlating the customer's activities to an image and for presenting, via the display, a second image, wherein the second image is the image associated with the customer's activities.

The features, functions, and advantages that have been discussed may be achieved independently in various embodiments of the present invention or may be combined with yet other embodiments, further details of which can be seen with reference to the following description and drawings

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a flow diagram illustrating a process flow for an apparatus for allowing a customer to choose a reward, in accordance with embodiments of the invention.

FIG. 2 is a flow diagram illustrating a process flow for an apparatus for assigning activities to activity segments and providing rewards based in part on the activity segment, in accordance with embodiments of the invention.

FIG. 3 is a visual representation of the process flows discussed herein.

FIG. 4 is a flow diagram illustrating a process flow for an apparatus for allowing customers to choose their rewards by creating a social network, in accordance with embodiments of the invention.

FIG. 5 is a block diagram illustrating technical components of a system for allowing a customer to choose a reward, in accordance with embodiments of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

Although embodiments of the present invention described herein are generally described as involving a merchant, it will be understood that merchant may involve one or more persons, organizations, businesses, institutions and/or other entities such as financial institutions, services providers etc. that implement one or more portions of one or more of the embodiments described and/or contemplated herein.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Thus, apparatus, systems, methods and computer program products are herein disclosed for allowing a customer to choose rewards as part of a customer incentive program. Inasmuch as financial institutions often offer customer incentives programs, specific embodiments disclosed herein relate to financial institutions. However, such embodiments are exemplary.

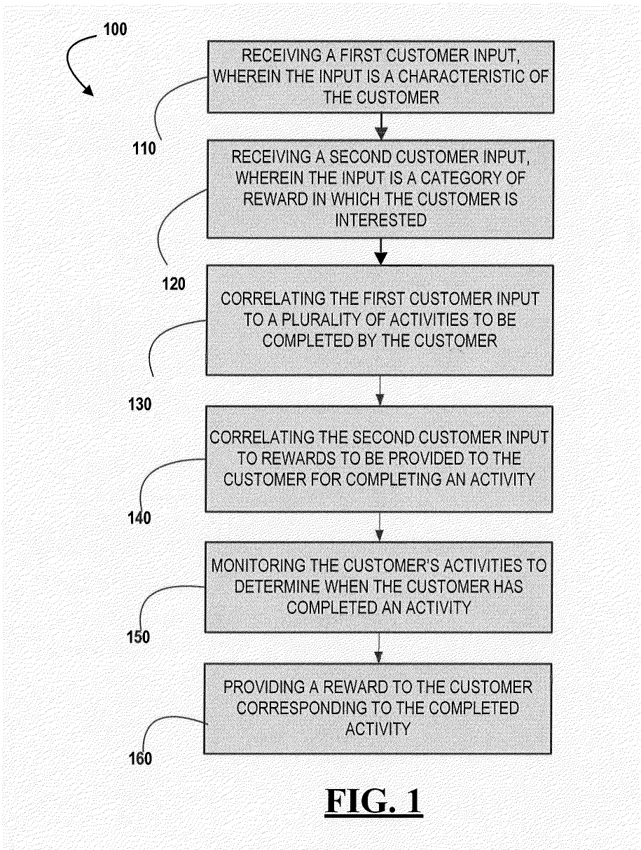

FIG. 1 illustrates a general process flow 100 for an apparatus or system for allowing a customer to choose a reward, in accordance with embodiments of the invention. As shown in block 110 a first customer input is received, wherein the first customer input is a characteristic of the customer. Such a characteristic may be any distinguishing function, feature or quality of the customer. In some embodiments, the customer will be presented with a discrete number of characteristics and the customer will be invited to indicate the characteristic with which the customer most closely identifies. In some such embodiments, the discrete number of characteristics is presented in the form of cards, each card being identified by a specific characteristic. The cards may be physical cards, like a playing cards, or the cards may be an electronic representation of cards (e.g. a graphical representation of a card presented on a display in connection with a website, mobile application or computer program). In specific embodiments, the cards will be called “I AM” cards and will identify the budgeting characteristics of the customer of a financial institution. Such budgeting characteristics may include “Organized Planner,” “Informed Decision Maker,” “Spender,” “Saver” or the like. However, in other embodiments, the characteristics may relate to the customers attitude toward the merchant, such as “Enthusiast,” “Fan,” “Support,” “Sustainer” or the like. In other embodiments, the customer will be able to input any characteristic. For instance, the customer may be presented with a data field and be given an opportunity to type a characteristic into the data field and submit the characteristic to be processed by the apparatus or system. In some embodiments the customer may elect to be randomly assigned a characteristic. In such embodiments, the customer will be randomly assigned a characteristic from a predetermined list of characteristics.

As shown in block 120, a second customer input is also received, wherein the second customer input is a category of reward in which the customer is interested. Such categories may be any general category of products or services, including without limitation, fashion, sports, technology, gaming, electronics, tools, entertainment, etc. As with the first customer input, the customer may be presented with a discrete number of product categories. In some such embodiments, the discrete number of categories are presented in the form of cards (either physical or electronic), with each card being identified by a specific category. In specific embodiments, the cards will be called “I LIKE” cards and will identify the category of goods or services in which the customer wishes to receive rewards. In other embodiments, the customer will be able to input any category of products or services. For instance, the customer may be presented with a data field and be given an opportunity to type a category into the data field and submit the category to be processed by the apparatus or system. Also, as with the first input, a customer may be able to elect to be randomly assigned a rewards category. In such instances, the customer will be randomly assigned a rewards category from a predetermined list of categories.

As shown in block 130, the first customer input is correlated to a plurality of activities to be completed by the customer. Such activities may include, but are not limited to participating in a specified program (e.g. participating in a budgeting program, research savings or investing goals online, posting a question or answering a question on a forum established by the merchant etc.), maintaining a specified balance in an account (e.g. maintaining $500 or more in a savings account), meeting specific goals (e.g. staying on budget for a month, depositing $50 a month into a savings account for six months, spending $10 or more every week at a grocery store etc.), using online tools provided by the merchant (e.g. create a budget or budget template using a program provided by a financial institution), completing a transaction with a specified financial instrument (e.g. a designated credit card or debit card), remaining a customer of the merchant for a specified period of time, or referring other customers to become customers of the merchant, and the like. By way of example continuing with the examples provided above, if the characteristic identified by the customer or randomly selected for the customer (e.g. the “I AM” card selected by the customer) is “Organized Planner,” this characteristic may correlate to setting up a budget, creating a savings goal, staying on budget for a month, meeting savings goal target for three months, creating a budget template etc. Similarly, if the characteristic identified by, or assigned to, the customer is “Informed Decision Maker”, this characteristic may correlate to using a budget creation tool, researching savings goals online, posting a question on a forum, answering a question on a forum, modifying a budget template etc. In some embodiments, each characteristic may be associated with completely separate activities from those activities associated with other characteristics. However, in other embodiments, there may be some overlap in the activities correlated to a characteristic. For instance, the Organized Planner and the Informed Decision Maker may both be associated with creating a budget.

As illustrated by block 140, the second customer input is correlated to rewards to be provided to the customer for completing an activity. Such rewards can be any incentive or inducement to encourage the customer to complete an activity and include, but are not limited to discounts for goods or services provided by the merchant, discounts for goods or services provided by other merchants, offers for services otherwise unavailable to the customer (e.g. VIP services, preferred customer services etc.), reductions in services fees (e.g. reductions to overdraft fees, balance transfer fees, ATM fee etc.) and the like. For example, if the category of reward identified by the customer (e.g. the “I LIKE” card selected by the customer) is a fashion card, the correlated rewards may be a 5% discount to a clothing retailer, free shipping on a product order, a $15 gift card, fee membership to VIP services at a department store etc. If the category of reward identified by the customer is electronics, the correlated rewards may be a 10% discount to an electronics retailer, free set-up or installation services, access to preferred software support etc. In addition to identifying specific rewards associated with the identified second customer input, the rewards are also associated with a corresponding activity. For instance, a 5% discount to a clothing retailer may be associated with creating a budget or creating a savings goal. The free shipping reward may be associated with staying within a budget for one month or meeting the savings target etc.

At block 150, the customer's activities are monitored to determine when the customer has completed an activity. Monitoring the customer's activities may be done in any manner sufficient to determine that the customer has completed an activity. However, in some embodiments monitoring the customer's activities will involve monitoring the transactional data and/or customer account history data available to the merchant. Transactional data includes, but is not limited to, data regarding the date, location, amount, method of payment etc. of the transactions of the customer. Account history data includes, without limitation, such data as the types of accounts the customer has with the merchant (e.g. credit, checking, savings, investment, lay-away, financing etc.) and the current and historical balances of such accounts, account activity etc. Accordingly, by way of example, if a financial institution has identified a reward to be given a customer for staying within a budget, the financial institution may be able to monitor the customer's transactional data to determine if the amounts and categories of spending are consistent with the budget. Similarly if a merchant, such as a retailer, has identified a reward to be given to any customer that enrolls in the merchant's credit card program and spends $100 in the first month, the merchant may monitor the customer's account history data to determine if this activity has been completed. A customer's activities may also be monitored by monitoring the social network data and Internet data about the customer available to the merchant. It will be understood that “social network” as used herein, generally refers to any social structure made up of individuals (or organizations) which are connected by one or more specific types of interdependency, such as kinship, friendship, common interest, financial exchange, working relationship, dislike, relationships, beliefs, knowledge, prestige, geographic proximity etc. The social network may be a web-based social structure or a non-web-based social structure. In some embodiments, the social network may be inferred from financial transaction behavior, mobile device behaviors, etc. The social network may be a network unique to the invention or may incorporate already-existing social networks as well as any one or more existing web logs or “blogs,” forums and other social spaces. Social network data may provide information regarding the customer's recent, present or future activities through expressed data. For instance, a user may upload a blog post, comment on a connection's page, send a friend an electronic message etc. that she cannot go away for the weekend because she is trying to stay within a budget. Similarly, a user might post a statement indicating that she purchased a luxury item, such as jewelry or new shoes suggesting that the customer has exceeded a budget limitation or failed to meet a savings goal. Monitoring a customer's activities may also be done by monitoring Internet data associated with the customer. Internet data, may include any information relating to the searches conducted by the customer, website's visited by the customer and the like that suggests the customer's activities. For instance, if a customer visits a number of websites comparing the costs of an item prior to making a purchase, it may suggest that the customer is actively attempting to adhere to a budget. Similarly, if a customer accesses a financial institution's website to collect additional information regarding different home equity options the customer may have completed an activity associated with being a Financial Planner.

As shown in block 160, the reward corresponding to the completed activity is provided to the customer. It will be understood that how the reward is provided to the customer will depend on the nature of the reward. In certain embodiments, the reward may be completely electronic and the delivery of the reward is conducted through a suitable means, such as an electronic message, SMS text, secure website, mobile application, software program etc. In embodiments where the reward is a physical item, providing the reward to the customer may involve physically shipping or transporting the reward to the customer.

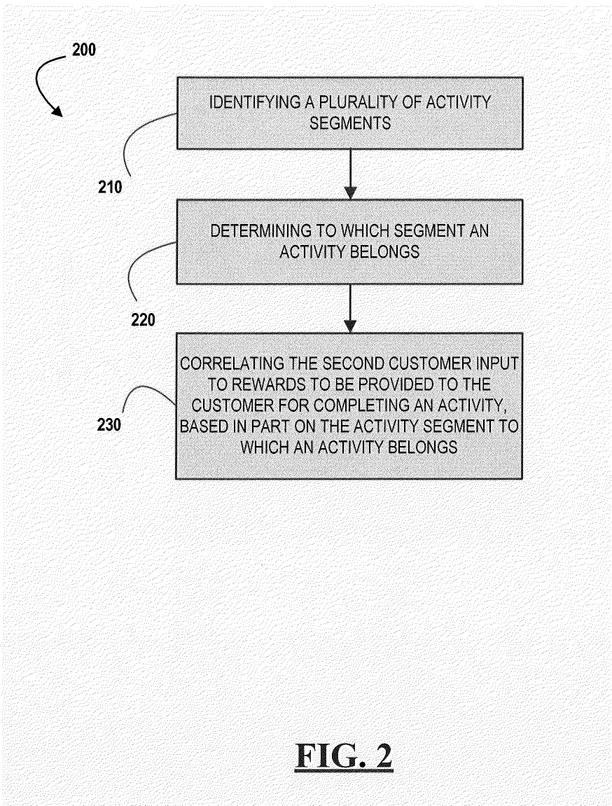

FIG. 2 provides a general process flow 200, for assigning activities to activity segments and providing rewards based in part on the activity segment, in accordance with embodiments of the invention. As shown in block 210, a plurality of activity segments are identified. Activity segments, in some embodiments will be expressed as levels, e.g Level 1, Level 2, Level 3. In other embodiments, the activity segments may be expressed as qualitative rankings, e.g. Beginner, Intermediate, Expert etc. The activity segments may be made according to any basis by which activities can be differentiated. In some embodiments, the activity segments may be according to the value of the completion of the activity to the merchant. So, for instance, if an activity represents a $100 revenue benefit to the merchant and a different activity represents a $50 revenue benefit to the merchant, the $50 activity may be labeled a Level 1 activity and the $100 activity may be labeled a Level 2 activity etc.

As shown at block 220, it is determined to which activity segment an activity belongs, and at block 230, correlating the second customer input to rewards to be provided to the customer for completing an activity is based in part on the activity segment to which an activity belongs. Accordingly, in certain embodiments, the completion of certain activities will provide access to different rewards. In some instances, the segmentation of activities will create a parallel segmentation of rewards. So, for example, completion of a Level 1 activity provides access to a Level 1 reward. Completion of a Level 2 activity provides access to a Level 2 reward, and so on. In such embodiments, the rewards available for completion of higher level activities will be more valuable than the rewards available for the completion of lower level activities. For example, consider a customer of a financial institution that identifies herself as a “Saver” and has indicated she is interested in rewards in the category of sports. The Saver characteristic may be associated with a Level 1 activity of researching available stocks and mutual funds using the financial institution's investment tools, a Level 2 activity of purchasing one or more shares of stocks or a mutual fund and a Level 3 activity of adjusting an investment portfolio by selling a stock and buying a different stock. Completion of the Level 1 activity may be correlated to a 10% discount for the purchase of running shoes. Completion of the Level 2 activity may be correlated to a $25 gift card to an athletics department store. Completion of the Level 3 activity may be correlated to free tickets to a sporting event. In some embodiments, the customer may be required to complete more than one activity before a reward is received. Furthermore, in some embodiments, the customer will have the option, in lieu of, or in addition to, receiving a reward corresponding to the completed activities of selecting a new reward category. Accordingly, in embodiments where the customer inputs are embodied as cards, the customer will have the opportunity to select a new “I LIKE” card.

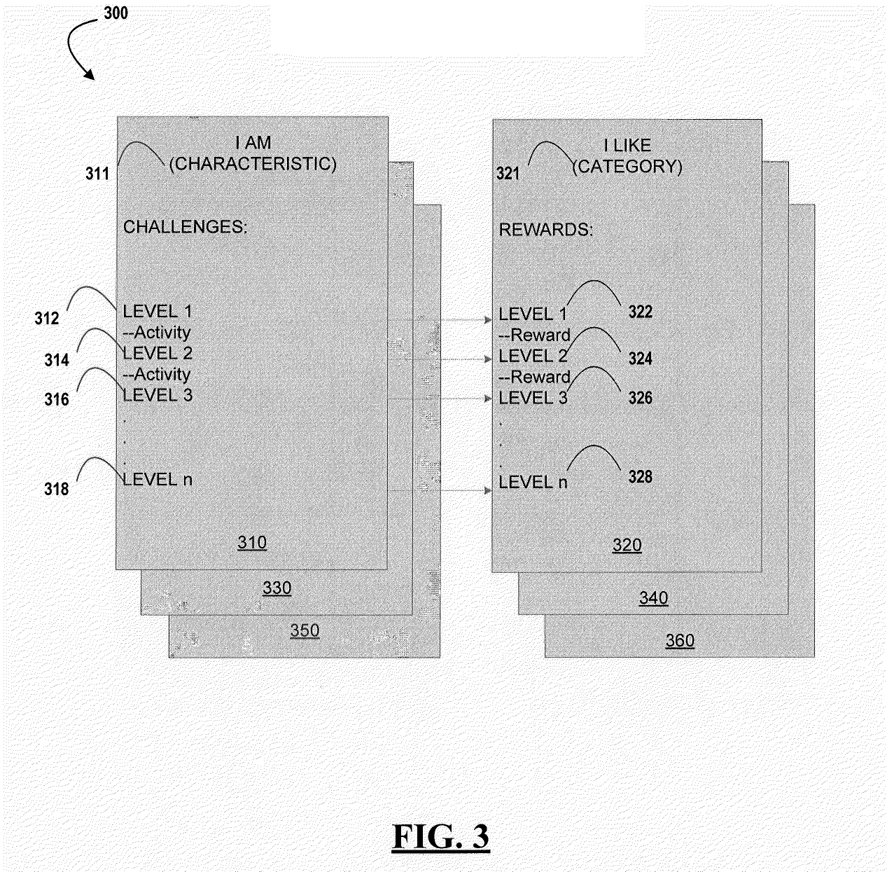

Referring now to FIG. 3 wherein a visual representation 300 of the process flows discussed herein is provided. Block 310, is a representation of an “I AM” card consistent with an embodiment of the present invention. As shown, an I AM card identifies a characteristic 311 that corresponds to one or more activities and each activity is divided into a separate activity segment, e.g. Level 1 (312), Level 2 (314), Level 3 (316) up to any number of levels, represented as Level n (318). Block 320, is a representation of an “I LIKE” card consistent with an embodiment of the present invention. As shown, an “I LIKE” card identifies a category 321 that corresponds to the rewards shown in the card. As with the activities, each reward is divided into segments to correspond to a correlated activity segment (block 230, FIG. 2), e.g. Level 1 (322), Level 2 (324), Level 3 (326) up to any number of levels, represented as Level n (328). As shown in FIG. 3, when a customer completes an activity, the customer is provided with the reward associated with the corresponding Level. For instance, completion of the activit(ies) under Level 2 (314) of the I AM card 310, will result in the customer being provided with the rewards under Level 2 (324) of the I LIKE card 320. Also shown in FIG. 3 are additional I AM cards (330 and 350) and additional I LIKE cards (340 and 360). In use, when a customer enrolls, or otherwise agrees to participate in the customer incentive program, the customer is given the opportunity to select one I AM card 310 and one I LIKE card 320 according to the characteristics of the customer and the category of rewards the customer is interested in receiving, respectively. Alternatively, the customer may elect to be randomly assigned one I AM card 310 and/or one I LIKE card 320 or choose one I AM card 310 and be randomly assigned one I LIKE card 320, or vise versa. The I AM cards list activities that the customer must complete to receive the corresponding rewards listed in their I LIKE cards. After completing the Level 1 activity (312) in the I AM card 310, the customer moves on to the next level, e.g. Level 2 (314) in that card. The customer can then either choose a new I LIKE card (e.g. 340, 360) or move on to the next level, e.g. Level 2 (324), of the current I LIKE card 320. Once a customer completes all of the activities associated with the selected I AM card 310, (e.g. the activities associated with Level n 318) the customer may be given the opportunity to select a new I AM card (e.g. 330, 350).

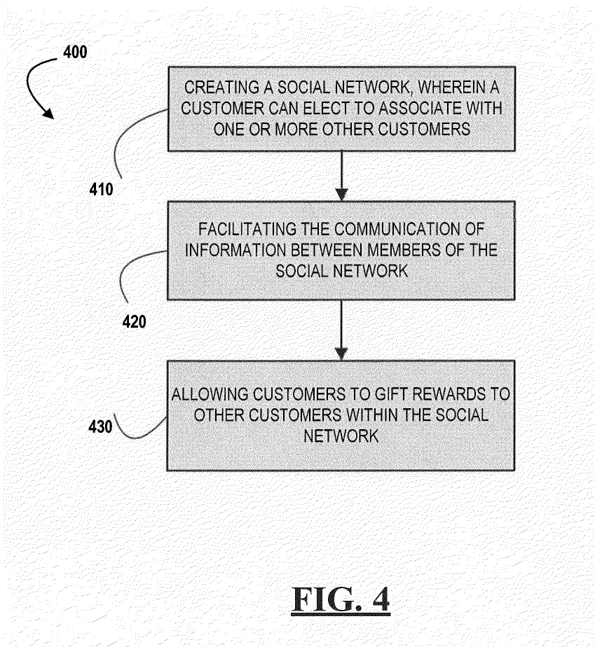

FIG. 4 is a process flow 400 illustrating a process flow for allowing customers to choose their rewards by creating a social network, in accordance with embodiments of the invention. As shown in block 410 a social network is created, wherein a customer can elect to associate with one or more other customers. It will be understood that “connection” or “connections” as used herein in the context of a social network refers to one or more members of a customer's social network. In certain embodiments, as shown in Block 420, connections within the social network will be able to communicate with each other, for instance through electronic message, chat, updates, postings and the like. Moreover, in some embodiments connections may be able to receive and view information regarding their connections' completion of activities and/or receipt of rewards. For example, if Customer A is a customer of a financial institution and Customer A's brother Customer B, and co-worker Customer C are also customers of the financial institution, Customer A may choose to associate with Customer B and Customer C by becoming connections over the social network created by the financial institution. After becoming connections, Customer A may receive an indication that Customer B has completed one of two tasks necessary to complete Level 1 of an Organized Planner card. Similarly, Customers A and B may receive an indication that Customer C received a Level 3 fashion reward for completing Level 3 of a Saver card. In some embodiments these communications, may be purely voluntarily or automated by the social network, but in other embodiments, the connections may receive incentives for inviting new customers to join the social network and/or getting others to complete a specified activity. In some embodiments, a user may receive information regarding other customer's completion of activities, receipt of rewards, etc., wherein the identity of the other customer is concealed. For instance, a customer may receive an update indicating that another customer has completed a savings goal and received a specified reward. In such an embodiment, the identity of the other customer may be concealed to preserve the privacy of each customer. Alternatively, customers may elect to reveal such information to their connections within the social network.

In some embodiments, facilitating the communication of information between members of the social network, as represented by block 420, is accomplished through visual representations associated with the customer's assigned characteristic and/or the completion of activities associated with the characteristic. The visual representations, may be anything capable of conveying the nature of the assigned characteristic and progress towards completion of activities associated with that characteristic but include, without limitation avatars, graphical representations of the customer, status bars, meters, gauges, dials, etc. The visual representations will vary depending on the customer characteristic that the customer selected or was randomly assigned. For example, if the customer identified herself as a Saver, the visual representation may be an avatar holding an empty bag of money. As the customer completes activities associated with the Saver characteristic, the image of the avatar may change to show the empty bag of money slowly filling. It will be understood that the avatar associated with each characteristic will be different and unique to the associated characteristic so that other customers in the social network will understand the characteristic associated with the customer upon viewing the customer's visual representation, e.g avatar, as well as the customer's progress towards completing associated activities. In other embodiments, when a customer selects a characteristic, the chosen characteristic is associated with a visual representation and that visual representation is displayed so that the customer's connections within the social network can see the visual representation. A second image may also appear with the first image, wherein the second image is a visual representation associated with the customer's current activities. In such embodiments, as the customer completes activities associated with the characteristic, the second image will change to more closely resemble the first image, that is, the visual representation associated with the characteristic. In this way, customers receive visual feedback associated with their activities and other customers connected within the social network receive visual information about their connections' activities.

As shown in block 430, customers may also be able to gift rewards or other incentives to other customers within the social network to provide encouragement for the other customer to complete a specified activity. For example, a father may become connected to his college age son over the social network created by a financial institution. The father may receive notice through the social network that the son is attempting to complete an activity requiring the son to save $100 a month for three months. The father may also receive an indication that the son has successfully saved $100 for two months. To further encourage his son to complete the activity, the father may offer to gift the son $25, a gift card or the like if the son completes the activity. In some instances, the incentive offered by the customer to the other customer is a reward the first customer received for completing an activity. In other instances, the incentive will be unrelated to the customer's earned rewards. In some embodiments, the gifting will only be possible to a customer's connections within the social network but in other embodiments the gift may be designated for any customer meeting a specific attribute (i.e. completing a specific activity, or a customer falling within a specific demographic, etc.). The social network may be used to facilitate the exchange of the gift by monitoring the second customer's activities and only transferring the gift to the customer upon completion of the activity. In other instances, the social network will facilitate the exchange of the gift by enabling the connections to communicate with each other to indicate when the gift should be transferred.

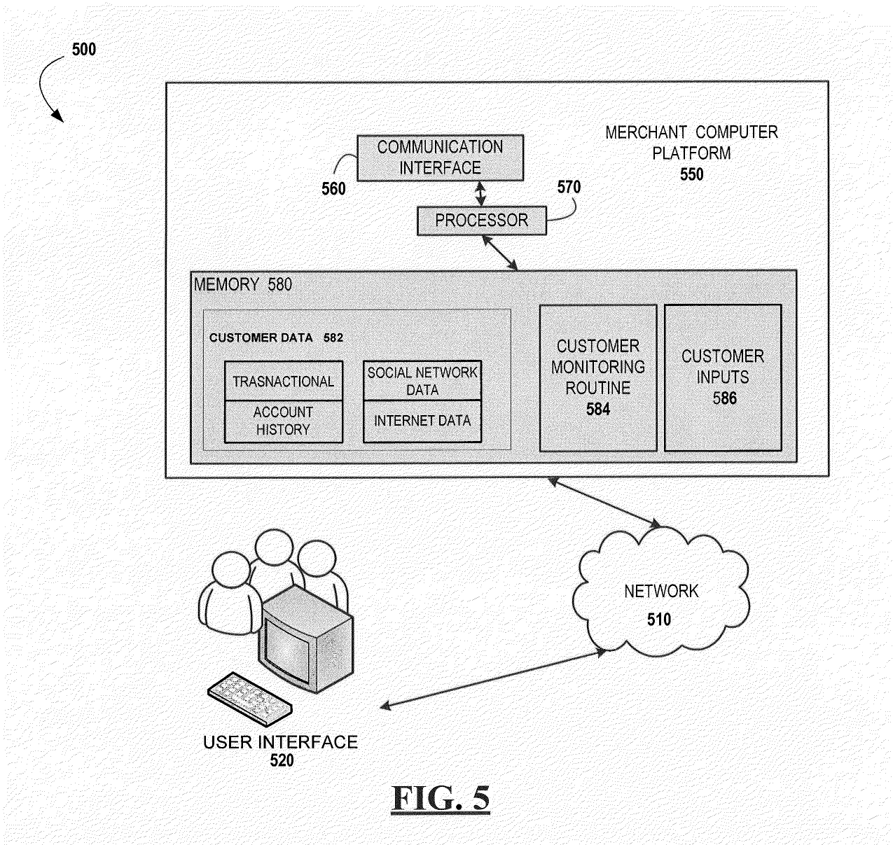

It will be understood that the method for allowing customers to choose their rewards as illustrated by the process flows 100, 200 and 400 of FIGS. 1-2 and 4 and the visual representation 300 of FIG. 3 can be embodied in a number of different apparatuses and systems. FIG. 5. provides a block diagram illustrating the technical components of such a system 500, in accordance with an embodiment of the present invention. As illustrated, the system 500 includes a network 510, a user interface 520 and a merchant computer platform 550.

The merchant computer platform 550 may include any computerized apparatus that can be configured to perform any one or more of the functions of the invention described herein. In accordance with some embodiments, for example, the merchant computer platform 550 may include an engine, a platform, a server, a database system, a front end system, a back end system, a personal computer system, and/or the like. In some embodiments, such as the one illustrated in FIG. 5, the merchant computer platform 550 includes a communication interface 560 a processor 570 and a memory 580. The communication interface 560 is operatively and selectively connected to the processor 570, which is operatively and selectively connected to the memory 580.

The communication interface 560, generally includes hardware, and, in some instances, software, that enables the merchant computer platform 550 to transport, send, receive, and/or otherwise communicate information to or from other communication interfaces. For example, the communication interface 560, may include a modem, server, electrical connection and/or other electronic devices that operatively connect the merchant computer platform 550 to another electronic device, such as the user interface 520.

The processor 570 generally includes circuitry or executable code for implementing the audio, visual, and/or logic functions of the merchant computer platform 550. For example, the processor may include a digital signal processor device, a microprocessor device, and various analog-to-digital converters, digital-to-analog converters, and other support devices. Control and signal processing functions of the system in which the processor resides may be allocated between these devices according to their respective capabilities. The processor 570 may also include functionality to operate one or more software programs based at least partially on computer-executable program code portions thereof, which may be stored, for example, in a memory device, such as the memory 580 of the merchant computer platform 550.

The memory 580, may include any computer-readable medium. For example, memory may include volatile memory, such as volatile random access memory (RAM) having a cache area for the temporary storage of data. Memory 580 may also include non-volatile memory, which may be embedded and/or may be removable. The non-volatile memory may additionally or alternatively include an EEPROM, flash memory, and/or the like. The memory 580 may store any one or more pieces of information and data used by the merchant computer platform 550 to implement the functions of the merchant computer platform 550. In some embodiments, as illustrated in FIG. 5, customer data (such as transactional data, account history data, social network data and Internet data) 582, a customer monitoring routine 584 and customer inputs 586 may be stored in memory 580. The customer data 580 may have been previously collected and stored in the memory 580 of the merchant computer platform 550, or the merchant computer platform may actively collect customer data 580 by using the communication interface 560 to access the network 510 and only temporarily saves the customer data 582 to the memory to be accessed by the processor 570.

It will be understood that the merchant computer platform 550 can be configured to implement one or more portions of the process flows described and/or contemplated herein. For example, in some embodiments, the merchant computer platform 550 may be configured to utilize the communication interface 560 to receive via the network 510 the first and second customer inputs (blocks 110-120, FIG. 1) provided by a customer using the user interface 520. In some embodiments, the customer inputs 586 may be stored in the memory 580 to be correlated by the processor 570 to activities to be completed by the customer and rewards to be provided to the customer for completing an activity (blocks 130-140, FIG. 1). Moreover, in certain embodiments the customer monitoring routine 584, stored in memory 580 is configured to monitor the customer's activities, including the customer data 582, to determine when the customer has completed an activity (block 150, FIG. 1).

As shown in FIG. 5, the merchant computer platform 550 and the user interface 520 are each operatively and selectively connected to the network 510, which may include one or more separate networks. In addition, the network 510, may include a local area network (LAN), a wide area network (WAN), and/or a global area network (GAN), such as the Internet. It will also be understood that the network 510 may be secure and/or unsecure and may also include wireless and/or wireline technology.

It will be understood that the merchant computer platform 550 in performing one or more portions of the process flows described and/or contemplated herein will operatively connect to the network 510 through the communication interface 560 to communicate or receive data. As discussed above, in receiving the first and second customer input merchant computer platform 550 may access the user interface 520 over the network 510 to electronically receive the customer's indication of a characteristic of the customer and category of reward in which the customer is interested. Similarly, in embodiments where the rewards are completely electronic, the merchant computer platform may provide the reward to the customer by using the communication interface 560 to operatively connect to the network 510 and transmit the data associated with the reward to the user interface 520.

As shown in FIG. 5, the system 500 may also include a user interface 520. In some embodiments, the user interface 520 includes one or more user output devices, such as a display and/or speaker, for presenting information to the customer. In some embodiments, the user interface 520 includes one or more user input devices, such as one or more buttons, keys, dials, levers, directional pads, joysticks, accelerometers, controllers, microphones, touch pads, touch screens, haptic interfaces, microphones, scanners, motion detectors, cameras, and/or the like for receiving information from the customer and/or some other user. In some embodiments, the user interface 520 includes the input and display devices of a personal computer, such as a keyboard and monitor, that are operable to receive and display information associated with allowing the customer to choose a reward. In some embodiments, the user interface includes the input and display devices of a mobile device (e.g. laptop, smartphone, PDA), such as a display and touch screen or keypad, that are operable to receive and display information associated with allowing the customer to choose a reward.

It will be understood that in some embodiments the user interface 520 is used by the customer to interact with the merchant computer platform to implement one or more portions of the process flows described and/or contemplated herein. By way of example, the merchant may create a secure website, mobile application, software program or the like that is operated at least in part by the merchant computer platform 550. The user interface 520 may be used to access the secure website, application or program over the network to provide customer input and/or receive a reward from the merchant etc.

It will be understood that the embodiment illustrated in FIG. 5 is exemplary and that other embodiments may vary. For example, in some embodiments, some or all of the portions of the system 500 may be combined into single portion. Specifically, in some embodiments, the merchant computer platform 550 is configured to perform all of the same functions of those separate portions as described and/or contemplated herein. Likewise, in some embodiments, some or all of the portions of the system 500 may be separated into two or more distinct portions.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A method for allowing a customer to choose a reward, the method comprising:
receiving a first customer input, wherein the first customer input is a characteristic;
receiving a second customer input, wherein the second customer input is a category of reward;
correlating the first customer input to a plurality of activities to be completed by the customer;
correlating the second customer input to rewards to be provided to the customer for completing an activity;
monitoring the customer's activities;
determining when the customer has completed one or more of the plurality of activities; and
providing a reward to the customer corresponding to the completed activity.

2. The method of claim 1, wherein the first customer input is an indication from the customer that the customer would like to be assigned a random characteristic and further comprising the step of assigning a random characteristic to the customer.

3. The method of claim 1, wherein the second customer input is an indication from the customer that the customer would like to be assigned a random category of reward and further comprising the step of assigning a random category of reward.

4. The method of claim 1, wherein the plurality of activities that are correlated to the first customer input are selected from: participating in a specified program, maintaining a specified balance in an account, meeting specific goals, using online tools provided by the merchant, completing a transaction with a specified financial instrument, remaining a customer of the merchant for a specified period of time, or referring other customer to become customers of the merchant.

5. The method of claim 1, where the rewards correlated to the second customer input are selected from: discounts for goods, discounts for services, access to preferred services, or reductions in assessments.

6. The method of claim 1, further comprising:
identifying a plurality of activity segments, wherein each segment corresponds to a value to the merchant of the completion of the activity by the customer; and
determining, via a processor, to which segment an activity belongs

7. The method of claim 6, wherein correlating the second customer input to rewards to be provided to the customer for completing an activity is based in part on the activity segment to which an activity belongs.

8. The method of claim 1, further comprising:
creating a social network, wherein a customer can elect to associate with one or more other customers.

9. The method of claim 8, wherein customers can communicate with other customers within the social network.

10. The method of claim 8, wherein customers can gift rewards to other customers within the social network.

11. The method of claim 9, wherein the gift is tied to the other customer's completion of an activity.

12. The method of claim 1, further comprising:
presenting, via a display, a first image, wherein the first image is a visual representation of the first customer input;
correlating the customer's activities to an image; and
presenting, via the display, a second image, wherein the second image is the image associated with the customer's activities.

13. The method of claim 12, wherein the first image and second image is an avatar.

14. The method of claim 12, wherein the second image is a visual representation of the first image modified to illustrate the customer's completion of activities associated with the first customer input.

15. The method of claim 12, wherein the first image is visible to other customers within the social network.

16. The method of claim 12, wherein the second image is visible to other customers within the social network.

17. An apparatus, comprising:
a user interface configured to receive a first and second customer input from a customer, wherein the first customer input is a characteristic and the second customer input is a category of regard;
a memory, operatively connected to the user interface, configured to store the first and second customer inputs; and
a processor operatively connected to the memory and the user interface and configured to:
correlate the first customer input to a plurality of activities to be completed by the customer;
correlate the second customer input to rewards to be provided to the customer for for completing an activity;
monitor the customer's activities;
determine when the customer has completed one or more of the plurality of activities; and
provide a reward to the customer corresponding to the completed activity

18. The apparatus of claim 17, wherein the first customer input is an indication from the customer that the customer would like to be assigned a random characteristic and wherein the processor is further configured to assign a random characteristic to the customer.

19. The apparatus of claim 17, wherein the second customer input is an indication from the customer that the customer would like to be assigned a random category of reward and wherein the processor is further configured to assign a random category of reward to the customer.

20. The apparatus of claim 17, wherein the plurality of activities that are correlated to the first customer input are selected from: participating in a specified program, maintaining a specified balance in an account, meeting specific goals, using online tools provided by the merchant, completing a transaction with a specified financial instrument, remaining a customer of the merchant for a specified period of time, or referring other customers to become a customer of the merchant.

21. The apparatus of claim 17, wherein the rewards correlated to the second customer input are selected from: goods, services, discounts for goods, discounts for services, access to preferred services, or reductions in assessments.

22. The apparatus of claim 17, wherein the processor is further configured to:
identify a plurality of activity segments, wherein each segment corresponds to a value to the merchant of the completion of an activity by the customer; and
determine to which segment an activity belongs.

23. The apparatus of claim 22, wherein correlating the second customer input to rewards to be provided to the customer for completing an activity is based in part on the activity segment to which an activity belongs.

24. The apparatus of claim 17, wherein the processor is further configured to create a social network, wherein customers can elect to associate with one or more other customers.

25. The apparatus of claim 24, wherein customers can communication with other customers within the social network.

26. The apparatus of claim 24, wherein customers can gift rewards to other customers within the social network.

27. The apparatus of claim 24, wherein the gift s tied to the other customer's completion of an activity.

28. The apparatus of claim 24, further comprising a display, operatively connected to the processor and wherein the processor is further configured to:
present, via the display, a first image, wherein the first image is a visual representation of the first customer input;
correlate the customer's activities to an image; and
present, via the display, a second image, wherein the second image is the image associated with the customer's activities.

29. The apparatus of claim 28, wherein the first image and second image is an avatar.

30. The apparatus of claim 28, wherein the second image is a visual representation of the first image modified to illustrate the customer's completion of activities associated with the first customer input.

31. The apparatus of claim 28, wherein the first image is visible to other customers within the social network.

32. The apparatus of claim 28, wherein the second image is visible to other customers within the social network.

33. A computer-program product, comprising:
a non-transitory computer-readable medium having computer-executable code stored thereon, the computer executable code comprising;
a first code portion stored in the memory and configured to receive a first customer input from a customer, wherein the first customer input is a characteristic;
a second code portion stored in the memory and configured to receive a second customer input, wherein the second customer input is a category of regard;
a third code portion stored in the memory and configured to correlate the first customer input to a plurality of activities to be completed by the customer;
a fourth code portion stored in the memory and configured to correlate the second customer input to rewards to be provided to the customer for completing an activity;
a fifth code portion stored in the memory and configured to monitor the customer's activities;
a sixth code portion stored in the memory and configured to determine when the customer has completed one or more of the plurality of activities; and
a seventh code portion stored in the memory and configured to provide a reward to the customer corresponding to the completed activity

34. The computer program product of claim 33, wherein the first customer input is an indication from the customer that the customer would like to be assigned a random characteristic and further comprising a code portion configured to assign a random characteristic to the customer.

35. The computer program product of claim 33, wherein the second customer input is an indication from the customer that the customer would like to be assigned a random category of reward and further comprising a code portion configured to assign a random category of reward to the customer.

36. The computer program product of claim 33, wherein the plurality of activities that are correlated to the first customer input are selected from: participating in a specified program, maintaining a specified balance in an account, meeting specific goals, using online tools provided by the merchant, completing a transaction with a specified financial instrument, remaining a customer of the merchant for a specified period of time, or referring other customers to become a customer of the merchant.

37. The computer program product of claim 33, wherein the rewards correlated to the second customer input are selected from: goods, services, discounts for goods, discounts for services, access to preferred services, or reductions in assessments.

38. The computer program product of claim 33, further comprising:
an eighth code portion stored in the memory and configured to identify a plurality of activity segments, wherein each segment corresponds to a value to the merchant of the completion of an activity by the customer; and
a ninth code portion stored in the memory and configured to determine to which segment an activity belongs.

39. The computer program product of claim 38, wherein correlating the second customer input to rewards to be provided to the customer for completing an activity is based in part on the activity segment to which an activity belongs.

40. The computer program product of claim 33, further comprising a tenth code portion stored in the memory and configured to create a social network, wherein customers can elect to associate with one or more other customers.

41. The computer program product of claim 40, wherein customers can communication with other customers within the social network.

42. The computer program product of claim 40, wherein customers can gift rewards to other customers within the social network.

43. The computer program product of claim 40, wherein the gifts tied to the other customer's completion of an activity.

44. The computer program product of claim 40, further comprising:
an eleventh code portion stored in the memory and configured to present, via a display, a first image, wherein the first image is a visual representation of the first customer input;
a twelfth code portion stored in the memory and configured to correlate the customer's activities to an image; and
a thirteenth code portion stored in the memory and configured to present, via the display, a second image, wherein the second image is the image associated with the customer's activities.

45. The computer program product of claim 44, wherein the first image and second image is an avatar.

46. The computer program product of claim 44, wherein the second image is a visual representation of the first image modified to illustrate the customer's completion of activities associated with the first customer input.

47. The computer program product of claim 44, wherein the first image is visible to other customers within the social network.

48. The computer program product of claim 44, wherein the second image is visible to other customers within the social network.
